(19) United States
(12) Patent Application Publication
(10) Pub. No.: US 2011/0211123 A1
(43) Pub. Date: Sep. 1, 2011

(54) METHOD AND DEVICE FOR IMPROVING THE VISIBILITY ESPECIALLY OF THIN LINES

(75) Inventors: Volker Blume, Tangstedt (DE); Stephan Gross, Kiel (DE)

(73) Assignee: NXP B.V., Eindhoven (NL)

(21) Appl. No.: 12/673,015

(22) PCT Filed: Aug. 7, 2008
(86) PCT No.: PCT/IB08/53177

§ 371 Date: Feb. 11, 2010

(30) Foreign Application Priority Data
Aug. 16, 2007 (EP) 07114442.2
Aug. 7, 2008 (IB) PCT/IB08/053177

(51) Int. Cl. H04N 5/00

(52) U.S. Cl. 348/607; 348/E07.001

(57) ABSTRACT

The invention relates to a method and a device to detect thin lines of an incoming signal, especially of an image or video signal, comprising the steps of: analysing the incoming signal, calculating the first derivative of the incoming signal (52), analysing and marking the crossing of zero of the fust derivative (53), analysing the direction of the zero crossing (54) and coding the direction into the zero-signal, eliminating noise and invalid alternating sequences to identify the existence of a thin line.

### FIELD OF THE INVENTION

The invention relates to a method and an electronic device for improving the visibility especially of thin lines.

### BACKGROUND OF THE INVENTION

The use of image data and video signals is growing and growing due to the fast development of new technologies within the field of computer technology, video technology and in the fast growing field of data transmission technology.

Therefore the quality of such image data or video data is very important and is one of the key factors for the acceptance of such new technology or such new products.

Sometimes especially thin lines of image or video data are wrongly represented after processing of the data and such data create the impression of broader representation of such thin lines.

For video or image processing the occurrence of thin lines have to be treated sometimes in a different way then the “normal” video content. Different video or image processing methods and for example the pCTI method suffers from an artefact which is visible as the enlargement of “thin lines”. In the context of processing in the chrominance domain and its normally sub-sampled representation the so called “thin line” can have an extended width which may be extended e.g. up to 25 pixels after up sampling.

U.S. Pat. No. 4,499,598 A discloses a method of extracting the magnitude and direction of edges and lines in a noisy image signal. The first and second derivatives of the image signal are analysed to identify an edge or line by identifying points were the first derivative is zero and the second derivative is non-zero. Identified edges and lines are then subjected to a thinning process.

US 2006/0045375 A1 discloses a method of measuring the width of an edge transition region by detecting zero crossing points of the second derivative of the image signal. Identified edge regions are processed to perform sharpening enhancement.

US 2005/0157940 A1 discloses a method of detecting edges by identifying zero crossing positions of the first derivative of the image signal to perform edge sharpening.

JP 2000-030052 discloses a method of measuring the width of thin lines within an image to perform sharpening. The width measurement is performed by analysing the gradation of the pixels and there appears to be no disclosure of analysing the zero crossings of the first derivative of the signal.

### OBJECT AND SUMMARY OF THE INVENTION

It is an object of the inventions to improve the visibility of thin lines in image or video data.

The above mentioned problems is solved by the method to detect thin lines of an incoming signal, especially of an image or video signal, comprising the steps of: analysing the incoming signal, calculating the first derivative of the incoming signal, analysing and marking the crossing of zero of the first derivative, analysing the direction of the zero crossing and coding the direction into the zero-signal, eliminating noise and invalid alternating sequences to identify the existence of a thin line.

According to another inventive aspect it is of advantage that the first derivative of the incoming signal is calculated as the steepness of two consecutive pixels of the incoming signal.

Furthermore it is of advantage that a coding into the zero-signal will be used, wherein a logical positive value will be used in case of a crossing from negative to positive values while a logical negative value will be used in case of a crossing from positive to negative values.

According to an other embodiment of the invention the coded signal will be evaluated to comprise a (−1,1,−1) change from negative to positive and to negative again or to comprise a (1,−1,1) change from positive to negative and to positive again.

Furthermore it is helpful that the steepness of two zero crossings will be used to eliminate noise and invalid alternating sequences.

According to another embodiment of the invention a reduction of the noise of a signal will be carried out by using a threshold while signals below the threshold will be set to zero and signals above the threshold will beset to a predetermined value.

Accordingly it is of advantage that a reduced or amended gain will be used to process the data within the range of pixels of the thin line.

The object of the invention regarding the device will be solved by an electronic device to detect thin lines of an incoming signal, especially of an image or video signal, comprising: means to analyse the incoming signal, means to calculate the first derivative of the incoming signal, means to analyse and mark the crossing of zero of the first derivative, means to analyse the direction of the zero crossing and code the direction into the zero-signal, means to eliminate noise and invalid alternating sequences to identify the existence of a thin line.

Furthermore the electronic device is useful for the application of the above mentioned method.

### BRIEF DESCRIPTION OF THE DRAWINGS

The above and other features and advantages of the invention will be apparent from the following description of an exemplary embodiment of the invention with reference to the accompanying drawings, in which:

FIG. 1a shows a representation of “thin line” with extended width;

FIG. 1b shows a representation of a “thin line” without extended width;

FIG. 2 shows a diagram displaying a thin line;

FIG. 3 shows a diagram to detect thin lines;

FIG. 4 shows a block diagram of the inventive method; and

FIG. 5 block diagram showing an example of the inventive device.

### DESCRIPTION OF EMBODIMENTS

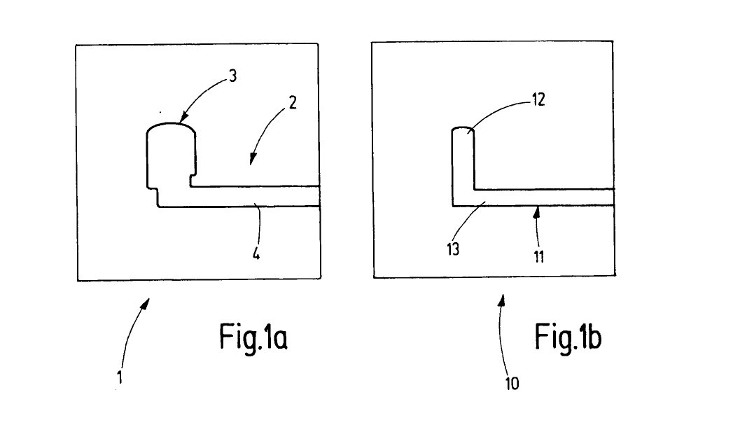

FIG. 1a and FIG. 1b both show a diagram 1 and 10 respectively, where in both diagrams 1, 10 a detail of a so called thin line 2, 11 is shown. The thin line of FIG, 1b consists of the horizontal segment 13 and of the vertical segment 12 of the thin line. Both segments 13, 12 of the thin line are almost identical in width. In contrast to the thin line of FIG. 1b the thin line of FIG. 1a consists of the horizontal segment 4 and of the vertical segment 3 of the thin line. Unfortunately both segments 4,3 of the thin line do not have the same width. The width of the vertical segment 3 is more extended compared with the width of the horizontal segment 4 of the thin line.

In order to eliminate or to improve the visibility of thin lines it is necessary to realise the existence of a thin line and to cover these special conditions a so called Line Width Detector has been invented in order to reduce the processing gain of a processing method e.g. like the so called peaked Chrominance Transient Improvement Method (pCTI) method locally and to keep the width of the “thin line” constant.

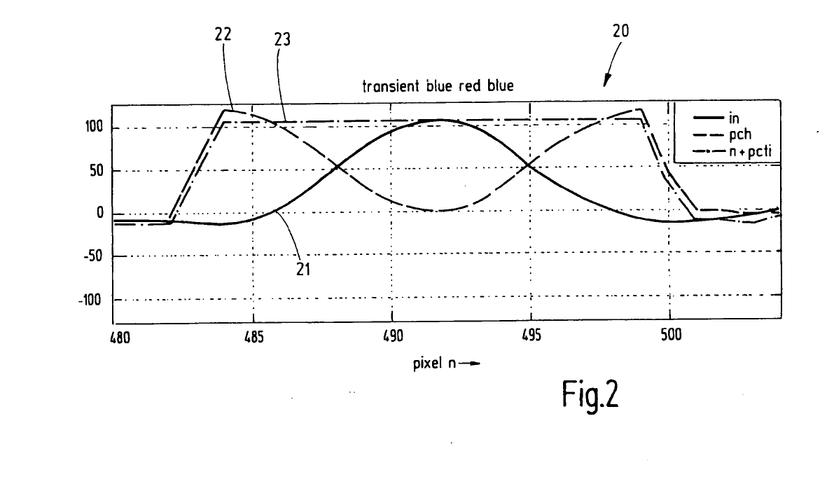

FIG. 2 shows a diagram 20 displaying a thin line 21 having an amplitude as a function of the number of pixels. The incoming signal shows the thin line and the processed signal 22 has two side bands with a maximum of the amplitude besides the maximum of the incoming signal. The addition of the signal of the incoming signal plus the signal of the processed signal leads to an almost flat signal 23 having a very broad plateau as shown in FIG. 2. Therefore the processing of the incoming original signal leads to a broadening of the thin line as described above.

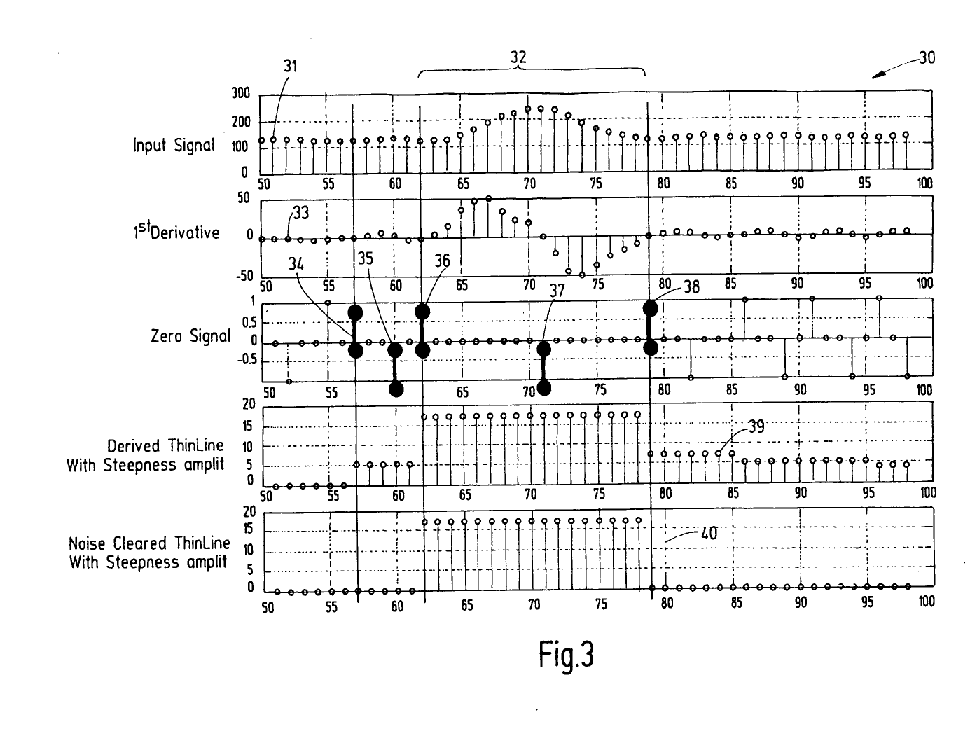

Therefore it is a result of the invention to detect the appearance of thin lines to be able to change the gain of the processing to restrict the broadening of a signal representing a thin line. The process of detection and thin line width determination is described in the diagram 30 of FIG. 3. The input signal 31 is taken from a real sequence where around pixel 63 up to 79 a visible thin line 32 is within the picture. The first processing step is the calculating the first derivative 33 which leads to an oscillating signal around zero by the removal of the DC part of the signal. The first derivative 33 will be now analysed where all zero crossings are marked 34, 35, 36, 37 and 38.

Concurrently the direction of the zero crossing will be coded into the zero-signal by using a logical positive one for crossing the zero line from negative to positive.

On the other hand the negative zero crossings, which means from positive to negative, are marked with a logical negative one.

The characteristic for a thin line requires alternating zero crossings which means the zero-signal will be analysed for consecutive (−1,1,−1) or (1,−1,1) sequences. All other sequences do not represent a line.

In order to separate noise and invalid alternating consecutive sequences of logical ones, the difference between two pixels from the input signal are taken into account.

This difference represents the steepness between two zero crossings and will be therefore a magnitude for the visibility of the line, see line 39. The resulting signal can be seen in the fourth diagram of FIG. 3. In order to remove the influence from noise, a simple threshold, which can be controlled by a noise estimator, will cut away invisible and noise polluted miss detection of thin lines, see line 40 of FIG. 3.

The Thin Line Detection method localises and measures the width of a thin line. Adaptively the processing effect e.g. of a pCTI method can be reduced around the range of the detected thin line in order to protect the picture from annoying enlargement of those kind of video structures.

This methodology can be used for Luminance, Chrominance, RGB Video signals or other signals.

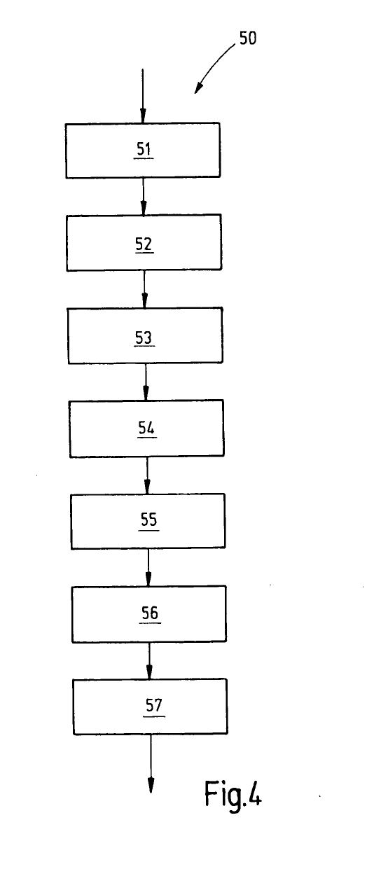

FIG. 4 shows a block diagram 50 to analyse the appearance of thin lines. In block 51 the incoming signal will be analysed. In block 52 the first derivative of the incoming signal will be calculated and analysed. In block 53 the crossing of zero of the first derivative will be calculated and marked. In block 54 the direction of the zero crossing will be coded into the zero-signal, wherein a logical positive value will be used in case of a crossing from negative to positive values while a logical negative value will be used in case of a crossing from positive to negative values. In step 55 the signal will be evaluated to comprise a (−1,1,−1) change from negative to positive and to negative again or to comprise a (1,−1,1) change from positive to negative and to positive again otherwise the signal does not represent a line. In block 56 the steepness of two zero crossings will be used to eliminate noise and invalid alternating sequences. Furthermore in block 57 to reduce the noise of a signal, a threshold will be used and signals below the threshold will be set to zero and signals above the threshold will beset to a predetermined value. At the end of block 57 a signal is generated which clearly shows the existence of a thin line and therefore within this range of pixels of the thin line a reduced or amended gain will be used to process the data within this range where a thin has been detected.

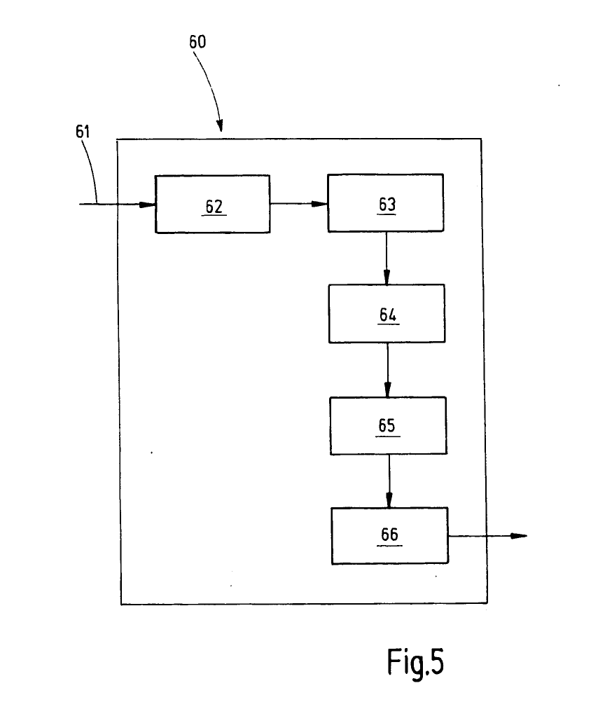

FIG. 5 shows a schematic view of an electronic device 60 to detect thin lines of an incoming signal 61, especially of an image or video signal, comprising: means 62 to analyse the incoming signal, means 63 to calculate the first derivative of the incoming signal, means 64 to analyse and mark the crossing of zero of the first derivative, means 65 to analyse the direction of the zero crossing and code the direction into the zero-signal, means 66 to eliminate noise and invalid alternating sequences to identify the existence of a thin line.

### REFERENCES

1 Diagram

2 thin line

3 segment

4 segment

10 diagram

11 thin line

12 segment

13 segment

20 diagram

21 thin line

22 signal

23 signal

30 diagram

31 input signal

32 thin line

33 first derivative

34 zero crossing

35 zero crossing

36 zero crossing

37 zero crossing

38 zero crossing

39 line

40 line

50 block diagram

51 block

52 block

53 block

54 block

55 block

56 block

57 block

60 diagram

61 input signal

62 means

63 means

64 means

65 means

66 means

1. Method for detecting thin lines of an incoming signal, comprising the steps of:
analysing the incoming signal;
calculating a first derivative of the incoming signal;
analysing and marking a crossing of zero of the first derivative;
analysing a direction of the zero crossing and coding the direction into the zero-signal, and
eliminating noise and invalid alternating sequences to identify an existence of a thin line.

2. Method according to claim 1, wherein the first derivative of the incoming signal is calculated as a steepness of two consecutive pixels of the incoming signal.

3. Method according to claim 1, wherein a coding into the zero-signal is used, wherein a logical positive value is used in case of a crossing from negative to positive values while a logical negative value is used in case of a crossing from positive to negative values.

4. Method according to claim 1, wherein the coded signal will be evaluated to comprise a change from negative to positive and to negative again or to comprise a change from positive to negative and to positive again.

5. Method according to claim 1, wherein the steepness of two zero crossings is used to eliminate noise and invalid alternating sequences.

6. Method according to claim 1, wherein a reduction of the noise of a signal is carried out by using a threshold so that signals below the threshold are set to zero and signals above the threshold are set to a predetermined value.

7. Method according to claim 1, wherein one of a reduced gain and an amended gain is used to process the data within a range of pixels of the thin line.

8. Electronic device for detecting thin lines of an incoming signal, comprising:
means for analyzing the incoming signal;
means for calculating a first derivative of the incoming signal;
means for analyzing and marking a crossing of zero of the first derivative;
means for analyzing a direction of the zero crossing and coding the direction into the zero-signal; and
means for eliminating noise and invalid alternating sequences for identifyin an existence of a thin line.

9. Electronic device according to claim 8 for the application of the method according to at least one of the claims 1 to 7.
